(19) United States
(12) Patent Application Publication
(10) Pub. No.: US 2013/0090419 A1
(43) Pub. Date: Apr. 11, 2013

(54) POLYCARBONATE COMPOSITIONS HAVING IMPROVED WATER RESISTANCE AND RELATED METHODS

(71) Applicants: Rick L. Archey, Pleasant Hills, PA (US); James P. Mason, Carnegie, PA (US); Pierre Moulinie, Oakdale, PA (US); Richard Peterman, Jefferson Borough, PA (US); Mary Ann Wittig, Carnegie, PA (US)

(72) Inventors: Rick L. Archey, Pleasant Hills, PA (US); James P. Mason, Carnegie, PA (US); Pierre Moulinie, Oakdale, PA (US); Richard Peterman, Jefferson Borough, PA (US); Mary Ann Wittig, Carnegie, PA (US)

(73) Assignee: Bayer MaterialScience LLC, Pittsburgh, PA (US)

(21) Appl. No.: 13/253,213

(22) Filed: Oct. 5, 2011

(51) Int. Cl. C08L 69/00; C08K 5/107; C08J 3/20; C08K 5/103

(52) U.S. Cl. 524/288; 524/307

(57) ABSTRACT

The present invention relates to compositions containing a polycarbonate including a bisphenol compound and an effective amount of a bishaloformate component present in an amount sufficient to reduce the average unbound bisphenol compound level found in water after immersion in deionized water for two weeks at 40° C. of the composition to less than about 20 ppb. Also provided are methods for increasing the water resistance of a polycarbonate composition. The method involves adding an effective amount of a bishaloformate component to the polycarbonate composition such that the polycarbonate composition has an average unbound bisphenol compound level found in water after immersion in deionized water for two weeks at 40° C. of less than about 20 ppb.

### FIELD OF THE INVENTION

This present invention relates in general to polycarbonate compositions, and more specifically, to polycarbonate compositions having improved water resistance.

### BACKGROUND OF THE INVENTION

Polycarbonate polymers are thermoplastic resins that are useful in a number of plastic material applications such as, injection molding, extrusion, rotation molding, blow molding, thermoforming, and the like. Polycarbonate thermoplastic resins exhibit a number of advantageous material properties and mechanical properties including, high impact strength, excellent dimensional stability, glass-like transparency, excellent thermal resistance, and low-temperature toughness. These properties, among others, make polycarbonate thermoplastic resins attractive as engineering materials for a wide variety of applications such as, automotive and transportation, building and construction, electrical and electronics, telecommunication, packaging, medical, optical/ophthalmic, and optical media. In some applications, water resistance is an important property, for example, in food contact packaging materials, such as food and drink containers.

### SUMMARY OF THE INVENTION

The present invention provides compositions containing a polycarbonate including a bisphenol compound and an effective amount of a bishaloformate component present in an amount sufficient to reduce the average unbound bisphenol compound level found in water after immersion in deionized water for two weeks at 40° C. of the composition to less than about 20 ppb. Also provided are methods for increasing the water resistance of a polycarbonate composition. The method involves adding an effective amount of a bishaloformate component to the polycarbonate composition such that the polycarbonate composition has an average unbound bisphenol compound level found in water after immersion in deionized water for two weeks at 40° C. of less than about 20 ppb.

These and other advantages and benefits of the present invention will be apparent from the Detailed Description of the Invention herein below. It is understood that the invention disclosed and described in this specification is not limited to the embodiments summarized in this Summary.

### DESCRIPTION

Various embodiments are described and illustrated in this specification to provide an overall understanding of the structure, function, operation, manufacture, and use of the disclosed compositions and methods. It is understood that the various embodiments described and illustrated in this specification are non-limiting and non-exhaustive. Thus, the invention is not limited by the description of the various non-limiting and non-exhaustive embodiments disclosed in this specification. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicants reserve the right to amend the claims to affirmatively disclaim features or characteristics that may be present in the prior art. Therefore, any such amendments comply with the requirements of 35 U.S.C. §112, first paragraph, and 35 U.S.C. §132(a). The various embodiments disclosed and described in this specification may comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

Reference throughout this specification to “various embodiments,” “certain embodiments,” or the like, means that a particular feature or characteristic may be included in an embodiment. Thus, use of the phrase “in various embodiments,” “certain embodiments,” or the like, in this specification does not necessarily refer to a common embodiment, and may refer to different embodiments. Further, the particular features or characteristics may be combined in any suitable manner in one or more embodiments.

Thus, the particular features or characteristics illustrated or described in connection with various embodiments may be combined, in whole or in part, with the features or characteristics of one or more other embodiments without limitation. Such modifications and variations are intended to be included within the scope of the present specification.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, the present inventors reserve the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112, first paragraph, and 35 U.S.C. §132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “alkyl” refers to saturated aliphatic groups, including straight-chain alkyl groups, branched-chain alkyl groups, cycloalkyl (alicyclic) groups, alkyl substituted cycloalkyl groups, and cycloalkyl substituted alkyl groups, such as, for example, methyl, ethyl, n-propyl, isopropyl, n-butyl, sec-butyl, t-butyl, pentyl, n-hexyl, cyclopentyl and cyclohexyl and the like. In certain embodiments, a straight chain or branched chain alkyl may have 24 or fewer carbon atoms in its backbone (e.g., C₁-C₂₄ for straight chain, C₃-C₂₄ for branched chain), such as 12 or fewer, 10 or fewer, and such as 8 or fewer.

As used herein, term “alkenyl” refers to unsaturated aliphatic groups, including straight-chain alkenyl groups, branched-chain alkenyl groups, cycloalkenyl (alicyclic) groups, alkyl substituted cycloalkenyl groups, and cycloalkenyl substituted alkyl groups, containing at least one double bond, typically containing one to six double bonds, more typically one or two double bonds, such as, for example, ethenyl, n-propenyl, n-butenyl, octenyl, decenyl, and the like, as well as cycloalkenyl groups such as cyclopentenyl, cyclohexenyl and the like. In certain embodiments, a straight chain or branched chain alkenyl may have 24 or fewer carbon atoms in its backbone (e.g., C₂-C₂₄ for straight chain, C₃-C₂₄ for branched chain), such as 12 or fewer, 10 or fewer, and such as 8 or fewer.

As used herein, term “aryl” refers to unsaturated aromatic groups including one or more six-membered carbon rings in which the unsaturation may be represented by three conjugated double bonds, such as, for example, phenyl, naphthyl, anthryl, phenanthryl, biphenyl and the like, and which may optionally be substituted one or more of carbons of the ring.

As used herein, the notations “a” and “b” in reference to an organic group, wherein a and b are each integers or an integer range, indicate that the group may contain a or b atoms per group or that range of atoms per group. The terminology “Cₐ-C_{b}” in reference to an organic group, wherein a and b are each integers, indicates that the group may contain from a carbon atoms to b carbon atoms per group.

Unless otherwise indicated, all compound and composition levels refer to the active portion of that compound or composition, and are exclusive of impurities, for example, residual solvents or by-products, which may be present in commercially available sources of any compounds or compositions.

All percentages and ratios are calculated by weight unless otherwise indicated. All percentages and ratios are calculated based on the total weight of the compound or composition unless otherwise indicated.

The various embodiments disclosed and described in this specification are directed, in part, to compositions comprising a polycarbonate and a haloformate, and to methods of increasing the water resistance of polycarbonate compositions. The physicochemical processes involved in detection of bisphenol-A (“BPA”) in water in contact with polycarbonate is described in P. Mercea, J. Appl. Polym. Sci., 2009, 112, 579-593, which is incorporated by reference herein.

The present invention provides a composition, containing a polycarbonate comprising a bisphenol compound and an effective amount of an added bishaloformate component present in an amount sufficient to reduce the average unbound bisphenol compound level found in water after immersion in deionized water for two weeks at 40° C. to less than 20 ppb.

The present invention further provides a method for increasing the water resistance of a polycarbonate composition, the method involving adding an effective amount of a bishaloformate component to the polycarbonate composition such that the polycarbonate composition yields an average unbound bisphenol compound level found in water after immersion in deionized water for two weeks at 40° C. of less than 20 ppb.

The present invention yet further provides a composition containing a polycarbonate comprising bisphenol A residues and an effective amount of a bisphenol-A-bischloroformate, wherein the composition yields an average unbound bisphenol A level found in water after immersion in deionized water for two weeks at 40° C. of less than about 20 ppb.

In various embodiments, the polycarbonates may be, for example, homopolycarbonates, copolycarbonates, branched polycarbonates, polyester carbonates, and mixtures of any thereof. The polycarbonates may preferably have a weight average molecular weight of 10,000 g/mol to 200,000 g/mol, and in various embodiments, of 20,000 g/mol to 80,000 g/mol, 15,000 g/mol to 80,000 g/mol, or 24,000 g/mol to 32,000 g/mol. The polycarbonates may be thermoplastic polycarbonates. The thermoplastic polycarbonates may have a melt flow rate (determined according to ASTM D1238-04: Standard Test Method for Melt Flow Rates of Thermoplastics by Extrusion Plastometer, which is incorporated by reference herein) at 300° C. of preferably about 1 g/10 min to about 85 g/10 min, and in various embodiments, of preferably about 2 g/10 min to 30 g/10 min.

The polycarbonates may be prepared, for example, by the known diphasic interface process from a carbonic acid derivative such as phosgene and a dihydroxy compound by polycondensation (see, e.g., German Offenlegungsschriften Numbers 2,063,050; 2,063,052; 1,570,703; 2,211,956; 2,211,957; 2,248,817; 2,232,877; 2,703,376; 2,714,544, 3,000,610; 3,832,396; 3,077934; and Schnell, “Chemistry and Physics of Polycarbonates,” Interscience Publishers, New York, N.Y., 1964, which are all incorporated by reference herein).

In various embodiments, the polycarbonates may be aromatic polycarbonates. Aromatic polycarbonates may be prepared, for example, by reaction of diphenols with carbonic acid halides, such as phosgene, and/or with aromatic dicarboxylic acid dihalides, such as benzenedicarboxylic acid dihalides, by the interfacial process, optionally using chain terminators, for example, monophenols, and optionally using branching agents that are trifunctional or more than trifunctional, for example, triphenols or tetraphenols. Production of aromatic polycarbonates via a melt polymerization process by reaction of diphenols with, for example, diphenyl carbonate is likewise possible. In certain embodiments, the polycarbonates may be prepared from dihydroxy compounds having one of Formula (1) or Formula (2):

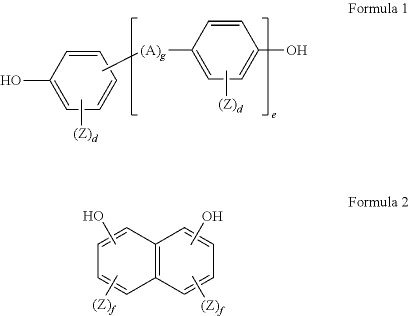

wherein A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO—, —SO₂—, or a radical having the Formula (3):

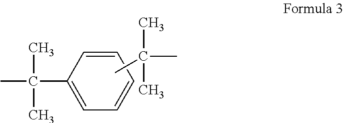

wherein e and g both denote the number 0 to 1; Z denotes F, Cl, Br or C₁-C₄-alkyl, and if several Z radicals are substituents in one aryl radical, they may be identical or different from one another; d denotes an integer of from 0 to 4; and f denotes an integer of from 0 to 3.

In various embodiments, dihydroxy compounds that may be used to produce polycarbonates include, for example, hydroquinone; resorcinol; bis-(hydroxyphenyl)-alkanes; bis-(hydroxyphenyl)-ethers; bis-(hydroxyphenyl)-ketones; bis-(hydroxyphenyl)-sulfoxides; bis-(hydroxyphenyl)-sulfides; bis-(hydroxyphenyl)-sulfones; 2,2,4-trimethylcyclohexyl-1,1-diphenol; α,α′-bis-(hydroxyphenyl)-diisopropylbenzenes; nuclear-alkylated derivatives thereof; and combinations of any thereof. Additional aromatic dihydroxy compounds that may be used to produce polycarbonates are described, for example, in U.S. Pat. Nos. 3,028,356; 2,999,835; 3,148,172; 2,991,273; 3,271,367; and 2,999,846, which are all incorporated by reference herein.

In certain embodiments, polycarbonates may be prepared from one or more bisphenol compounds. For example, polycarbonates may be prepared from bisphenol compounds including, but not limited to, 2,2-bis-(4-hydroxyphenyl)-propane (bisphenol A or BPA); 2,4-bis-(4-hydroxyphenyl)-2-methylbutane; 1,1-bis-(4-hydroxyphenyl)-cyclohexane; α,α′-bis-(4-hydroxyphenyl)-p-diisopropylbenzene; 2,2-bis-(3-methyl-4-hydroxyphenyl)-propane; 2,2-bis-(3-chloro-4-hydroxyphenyl)-propane; bis-(3,5-dimethyl-4-hydroxyphenyl)-methane; 2,2-bis-(3,5-dimethyl-4-hydroxyphenyl)-propane; bis-(3,5-dimethyl-4-hydroxyphenyl)-sulfide; bis-(3,5-dimethyl-4-hydroxyphenyl)-sulfoxide; bis-(3,5-dimethyl-4-hydroxy-phenyl)-sulfone; dihydroxybenzophenone; 2,4-bis-(3,5-dimethyl-4-hydroxyphenyl)-cyclohexane; α,α′-bis-(3,5-dimethyl-4-hydroxyphenyl)-p-diisopropylbenzene; 2,2,4-trimethyl cyclohexyl-1,1-diphenol; 4,4′-sulfonyl diphenol; 2,2-bis-(3,5-dibromo-4-hydroxyphenyl)-propane; and combinations of any thereof.

In various embodiments, polycarbonates may be prepared from at least one of 2,2,-bis-(4-hydroxyphenyl)-propane; 2,2-bis-(3,5-dibromo-4-hydroxyphenyl)-propane; 2,2-bis-(3,5-dimethyl-4-hydroxyphenyl)-propane; 2,2,4-trimethyl cyclohexyl-1,1-diphenol; and 1,1-bis-(4-hydroxyphenyl)-cyclohexane. The polycarbonates may include residue units in their structure derived from one or more bisphenol compounds.

In addition, polycarbonate resins may be used. The polycarbonate resins may include, for example, phenolphthalein-based polycarbonates, copolycarbonates, and terpolycarbonates, such as are described in U.S. Pat. Nos. 3,036,036 and 4,210,741, which are both incorporated by reference herein.

In certain embodiments, branched polycarbonates may be used. Branched polycarbonates may be produced, for example, by reacting via polycondensation a carbonic acid derivative such as phosgene, one or more dihydroxy compounds, and one or more polyhydroxyl compounds that function as branching agents. Branching agents that may be used include, phenols that are trifunctional or more than trifunctional, such as phloroglucinol; 4,6-dimethyl-2,4,6-tri-(4-hydroxyphenyl)-hept-2-ene; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis[4,4-bis-(4-hydroxyphenyl)-cyclohexyl]-propane; 2,4-bis-(4-hydroxyphenyl-isopropyl)-phenol; tetra-(4-hydroxyphenyl)-methane; 2,6-bis-(2-hydroxy-methyl-benzyl)-4-methyl-phenol; 2-(4-hydroxyphenyl)-2-(2,4-dihydroxyphenyl)-propane; tetra-(4-[4-hydroxy-phenyl-isopropyl]-phenoxy)-methane; 1,4-bis-[4′,4″-dihydroxy-triphenyl)-methyl]-benzene; combinations of any thereof. Multifunctional phenols may be used in amounts of from 0.01 mol percent to 1.0 mol percent based on the total amount of phenols employed. Multi-functional phenolic branching agents may be introduced with diphenols into reaction mixtures during polycarbonate synthesis.

In various embodiments, at least one polyhydroxyl compound may be reacted with a carbonic acid derivative and at least one dihydroxy compound in relatively small quantities, such as, for example, 0.05 mol percent to 2.00 mol percent (relative to the dihydroxy compounds present in the reaction mixture). Branched polycarbonates of this type are described, for example, in German Offenlegungsschriften Numbers 1,570,533; 2,116,974; and 2,113,374; British Patent Numbers 885,442 and 1,079,821; and U.S. Pat. No. 3,544,514, which are all incorporated by reference herein.

Examples of polyhydroxyl compounds useful in various embodiments to prepare branched polycarbonates include, but are not limited to, phloroglucinol; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane; 1,4-bis-(4,4′-dihydroxy-triphenylmethyl)-benzene; and combinations of any thereof. Examples of other polyfunctional compounds that may be used to prepare branched polycarbonates include, but are not limited to, 2,4-dihydroxybenzoic acid; trimesic acid; cyanuric chloride; 3,3-bis-(4-hydroxyphenyl)-2-oxo-2,3-dihydroindole; and combinations of any thereof. Chain terminators that may be used for the preparation of polycarbonates include, for example, phenol; p-chlorophenol; p-tert-butylphenol; 2,4,6-tribromophenol; and combinations of any thereof. Chain terminators that may also be used for the preparation of polycarbonates include alkyl-phenols such as, for example, 4-[2-(2,4,4-trimethylpentyl)]-phenol; 4-(1,3-tetramethylbutyl)-phenol; 3,5-di-tert-butylphenol; p-iso-octylphenol; p-tert-octylphenol; p-dodecylphenol; 2-(3,5-dimethylheptyl)-phenol; 4-(3,5-dimethylheptyl)-phenol; and combinations of any thereof. The amount of chain terminators employed may be between 0.5 mol percent and 10 mol percent, based on the total amount of phenols and diphenols employed in the polycarbonate synthesis.

Polyester carbonates may be prepared, for example, by co-reacting a carbonic acid derivative such as phosgene, a dihydroxy compound, and a dicarboxylic acid dihalides. Examples of suitable dicarboxylic acid dihalides include, for example, the diacid dichlorides of isophthalic acid; terephthalic acid; diphenyl ether 4,4′-dicarboxylic acid; and of naphthalene-2,6-dicarboxylic acid. Mixtures of any of these dicarboxylic acid dihalides are also suitable. For example, mixtures of the diacid dichlorides of isophthalic acid and of terephthalic acid in a ratio of between 1:20 and 20:1, or any sub-range subsumed therein, may be employed.

Branching agents that may be used to produce branched polyester carbonates include, for example, carboxylic acid chlorides that are trifunctional or more than trifunctional, such as trimesic acid trichloride; cyanuric acid trichloride; 3,3′,4,4′-benzophenone-tetracarboxylic acid tetra-chloride; 1,4,5,8-naphthalenetetracarboxylic acid tetrachloride; pyromellitic acid tetrachloride; or combinations of any thereof. Carboxylic acid chlorides may be used in amounts of from 0.01 mol percent to 1.0 mol percent based on the total amount of carboxylic acid chlorides employed. Multi-functional acid chloride branching agents may be introduced with acid dichlorides into reaction mixtures during polyester carbonate synthesis.

Examples of chain terminators suitable for the preparation of polyester carbonates include, in addition to the monophenols already mentioned, chlorocarbonic acid esters thereof and the acid chlorides of aromatic monocarboxylic acids, which may optionally be substituted by C₁-alkyl to C₂₂-alkyl groups or by halogen atoms, and aliphatic C₂- to C₂₂-monocarboxylic acid chlorides. The amount of chain terminators in each case may be 0.1 mol percent to 10 mol percent, based on the moles of diphenol in the case of the phenolic chain terminators and on the moles of dicarboxylic acid dichloride in the case of monocarboxylic acid chloride chain terminators.

The content of carbonate structural units in a polyester carbonate may vary. For example, the content of carbonate groups may be up to 100 mol percent, and in various embodiments, up to 80 mol percent or up to 50 mol percent, based on the sum of ester groups and carbonate groups. Both the ester and the carbonate content of a polyester carbonate can be present in the polycondensate molecule in the form of blocks or in random distribution.

In addition to general polycondensation processes, other reaction processes that may be used to prepare polycarbonates include, for example, transesterification, modified polycondensation in a homogeneous phase, and interfacial polycondensation. Examples of these and other processes for producing polycarbonates are described in U.S. Pat. Nos. 3,028,365; 2,999,846; 3,153,008; 2,991,273; and 3,912,688, which are incorporated by reference herein.

The reactants described above for the production of polycarbonates may be employed in any suitable reaction mixture to produce homo-polycarbonates, copolycarbonates, branched polycarbonates, or polyester carbonates. The resulting polycarbonate products may be used in polycarbonate compositions by themselves or in any suitable mixture.

In various embodiments, commercially-available polycarbonate resins may be used in polycarbonate compositions. Examples of suitable polycarbonate resins include, for example, the bisphenol-based polycarbonate resins available from Bayer MaterialScience LLC, Pittsburgh, Pa., USA, under the MAKROLON trademark. These resins include, for example, MAKROLON 2405, 2458, 2600, 2605, 2606, 2608, 2805, 3105, 3108, and 5308, as well as the various other grades of MAKROLON polycarbonate resins.

Additional polycarbonate resins that may be used in various embodiments are described, for example, in U.S. Pat. Nos. 3,030,331; 3,169,121; 3,395,119; 3,729,447; 4,255,556; 4,260,731; 4,369,303; 4,714,746; 5,693,697, which are all incorporated by reference herein, and in U.S. Patent Application Publications Nos. 200/0225441; 2007/0123634; 2008/0132617; 2009/008516; 2010/0160508; and 2011/0003918, which are also incorporated by reference herein.

In various embodiments, compositions of the present disclosure may include a polycarbonate and an effective amount of a haloformate, wherein the composition has an average unbound bisphenol compound level in water of less than 20 ppb. As used herein, an “effective amount” of a haloformate means an intentional addition of an amount of haloformate to the polycarbonate composition in an amount which is greater than the amount of haloformate normally formed in a polycarbonate composition through reaction or extrusion/re-extrusion, such as from residue units in their structure derived from one or more bisphenol compounds, and sufficient to reduce the average unbound bisphenol compound level in water to less than 20 ppb. As used herein, “average unbound bisphenol compound level” refers to the average level of an unbound bisphenol compound that is measured in a liquid. In various embodiments, “average unbound bisphenol compound level” refers to the average level of a bisphenol A that was found in deionized water at 40° C. after containing pellets of the polycarbonate composition for two weeks. The average unbound bisphenol compound level may be measured by known analytical methods, including, but not limited to, gas chromatography, liquid chromatography, mass spectrometry (ESI and MALDI MS), liquid-liquid extraction, HPLC/MS, HPLC/UV, and combinations thereof.

In various non-limiting embodiments, the haloformate component may be a chloroformate, a bishaloformate, an aromatic bishaloformate, a bischloroformate (BCF), such as a bisphenol-A-bischloroformate (BPA-BCF), and combinations thereof. The haloformate component may be present in the polycarbonate composition in various effective amounts. For example, the composition may include an amount of haloformate, such as chloroformate, bishaloformate, an aromatic bishaloformate, a bischloroformate (BCF), such as a bisphenol-A-bischloroformate (BPA-BCF), and any combination thereof, by weight percent of the composition, of one of greater than 0 to 1%, 0.05% to 1%, 0.05% to 0.75%, 0.05% to 0.5%, 0.05% to 0.25%, 0.1% to 2%, 0.1% to 1%, 0.1% to 0.75%, 0.1% to 0.5%, 0.1% to 0.3%, and 0.1% to 0.25%.

It has been found that in certain non-limiting embodiments the haloformate component may be selected such that its chemical structure generally matches the chemical structure of the polymer backbone of the polycarbonate composition to which it is added to effectively reduce the unbound bisphenol compound found in deionized water after immersion for two weeks at 40° C. to a level of less than 20 ppb. Because the polycarbonate composition may include residue units in their structure derived from one or more bisphenol compounds, suitable matching haloformate components may be chosen to most effectively target and reduce the unbound bisphenol compound of the polycarbonate.

In various embodiments, the haloformate may be a bishaloformate of Formula (4):

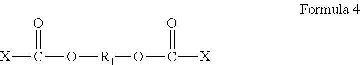

wherein R₁ may be selected from C₁-C₂₄ alkyl or substituted alkyl, C₃-C₂₄ cycloalkyl or substituted cycloalkyl, C₂-C₂₄ alkenyl or substituted alkenyl, C₆-C₂₄ aryl or substituted aryl, and X is independently selected from a halogen. In certain embodiments, X may be selected from the group consisting of chlorine, bromine, fluorine, and iodine. In at least one embodiment, X is chlorine.

In various embodiments, R₁ may be a C₁-C₂₄ alkyl or substituted alkyl or halide substituted alkyl or phenyl, alkoxy substitution, ester substitution, ether substitution, and phenyl substitution. In various embodiments, R₁ may be a C₃-C₂₄ substituted cycloalkyl selected from halide substitution, alkoxy substituted cycloalkyl, ester substituted cycloalkyl, or ether substituted cycloalkyl, or phenyl substituted alkyl. In certain embodiments, R₁ may be an ether group, such as, for example, —CH₂CH₂OCH₂CH₂—.

In various embodiments, R₁ may be a C₂-C₂₄ substituted alkenyl, halide substituted alkenyl, alkoxy substituted alkenyl, ester substituted alkenyl, ether substituted alkenyl, and phenyl substituted alkenyl.

In certain non-limiting embodiments, R₁ may be a C₆-C₂₄ substituted aryl, halide substituted aryl, alkoxy substituted aryl, ester substituted aryl, ether substituted aryl, and phenyl substituted aryl, such as, for example, methylphenyl, dimethylphenyl, hydroxyphenyl, chlorophenyl, and trichloromethylphenyl.

In various embodiments, the haloformate may be a bishaloformate of Formula (5):

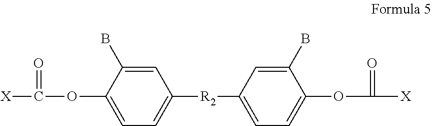

wherein R₂ may be selected from C₁-C₂₄ alkyl or substituted alkyl, C₃-C₂₄ cycloalkyl or substituted cycloalkyl, C₂-C₂₄ alkenyl or substituted alkenyl, C₆-C₂₄ aryl or substituted aryl, B is independently selected from —H and C₁-C₂₄ alkyl or substituted alkyl, and X is independently selected from the group consisting of chlorine and bromine. In various embodiments, R₂ may be any of the C₁-C₂₄ substituted alkyls, C₃-C₂₄ substituted cycloalkyls, C₂-C₂₄ substituted alkenyls, and C₆-C₂₄ substituted aryls described herein. In various embodiments, R₂ may be methyl, ethyl, propyl, butyl, pentyl, hexyl, heptyl, octyl, nonyl, decyl, undecyl, and dodecyl. In various embodiments, R₂ may be a substituted alkyl selected from the group consisting of —CH(CH₃)—, —C(CH₃)₂—, —C(CH₃)(CH₂CH₃)—, —C(CH₂CH₃)₂—, —CH₂CH(CH₃)—, —CH₂C(CH₃)₂—, —CH₂CH(CH₃)CH₂—, —CH₂C(CH₃)₂CH₂—, —CH₂CH₂CH(CH₃)CH₂CH₂—, —CH₂CH₂C(CH₃)₂CH₂CH₂— and —CH₂C₆H₁₀CH₂—. In at least one embodiment, R₂ may be —C(CH₃)₂—, a first B may be —H, a second B may be —CH₃, and X may be chlorine. In at least one embodiment, R₂ may be —C(CH₃)₂—, B may be —C(CH₃)₂—, and X may be chlorine.

In various embodiments, the haloformate may be bisphenol-A-bischloroformate (BPA-BCF) of Formula (6):

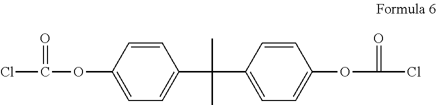 [SMILES: CC(C)(c1ccc(OC(=O)Cl)cc1)c1ccc(OC(=O)Cl)cc1]

In various embodiments, the haloformate may be one of 1,1-bis(4-hydroxyphenyl)-1-phenyl-ethane (Bisphenol AP) bischloroformate (BPAP-BCF), 2,2-bis(4-hydroxyphenyl)butane (Bisphenol B) bischloroformate (BPB-BCF), bis-(4-hydroxyphenyl)diphenylmethane (Bisphenol BP) bischloroformate (BPBP-BCF), 2,2-bis(3-methyl-4-hydroxyphenyl)propane (Bisphenol C) bischloroformate (BPC-BCF), 1,1-bis(4-hydroxyphenyl)ethane (Bisphenol E) bischloroformate (BPE-BCF), bis(4-hydroxydiphenyl)methane (Bisphenol F) bischloroformate (BPF-BCF), 2,2-bis(4-hydroxy-3-isopropyl-phenyl)propane (Bisphenol G) bischloroformate (BPG-BCF), 1,3-bis(2-(4-hydroxyphenyl)-2-propyl)benzene (Bisphenol M) bischloroformate (BPM-BCF), 1,4-bis(2-(4-hydroxyphenyl)-2-propyl)benzene (Bisphenol P) bischloroformate (BPP-BCF), 5,5′-(1-methylethyliden)-bis[1,1′-(bisphenyl)-2-ol]propane (Bisphenol PH), bischloroformate (BPPH-BCF), bis(4-hydroxyphenyl)sulfone (Bisphenol S) bischloroformate (BPS-BCF), 1,1-bis(4-hydroyphenyl)-3,3,5-trimethyl-cyclohexane (Bisphenol TMC) bischloroformate (BPTMC-BCF), 1,1-bis(4-hydroxyphenyl)-cyclohexane (Bisphenol Z) bischloroformate (BPZ-BCF), 1,4-butanediol-bischloroformate, 1,4-cyclohexane-bischloroformate, 2,2-dimethylpropane-1,3,-diyl-bischloroformate, 3-methylpentane-1,5-diyl-bischloroformate, ethylene-bischloroformate, hexamethylene-bischloroformate, and triethylene glycol bischloroformate.

In various embodiments, the haloformate may be diethylene glycol bischloroformate of Formula (7):

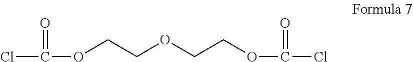 [SMILES: O=C(Cl)OCCOCCOC(=O)Cl]

When the haloformate component is added to the polycarbonate composition in effective amounts, such as those provided herein, the composition may have an average unbound bisphenol compound level in water of less than 20 ppb, and may range from 0 to 20 ppb, 0 to 15 ppb, and 1 ppb to 10 ppb according to the various methods for determining the average unbound bisphenol compound level described herein. In various embodiments, the composition may be such that average unbound bisphenol A found after immersion of the composition for 2 weeks in deionized water at 40° C. to a level of less than 20 ppb, may range preferably from 0 to 20 ppb, more preferably from 0 to 15 ppb, and most preferably from 1 ppb to 10 ppb. The composition may be one of free, substantially free, and completely free of bisphenol A scavengers. As used herein, the term “substantially free” means that the scavenger is present, if at all, as an incidental impurity. As used herein, the term “completely free” means that the scavenger is not present at all. Bisphenol A scavengers are described in U.S. Pat. No. 5,807,912, which is incorporated by reference herein. Examples of bisphenol A scavengers include, but are not limited to, trimethylbenzoate, a-cyclodextrine or an epoxidized-bisphenol A.

In various embodiments, the composition may be a homogeneous composition including the polycarbonate and bishaloformate. In certain embodiments, the composition may be a heterogeneous mixture of the polycarbonate and bishaloformate. The heterogeneous mixture may be characterized by uniform dispersion of the bishaloformate in the polycarbonate. In various embodiments, the interaction between the polycarbonate and bishaloformate may be one or more of covalent bonding, non-ionic bonding, hydrogen bonding, and van der Waals bonding. In various embodiments, the interaction between the polycarbonate and bishaloformate may not be covalent bonding. For example, the composition may include a polycarbonate including a BPA residue unit, and a bishaloformate, such as, BPA-BCF, wherein the BPA-BCF is not covalently bonded to the polycarbonate. In various embodiments, the composition may include a binary mixture of the polycarbonate and bishaloformate.

According to certain embodiments, the addition of the bishaloformate, such as, for example, BPA-BCF, to the polycarbonate composition may increase the water resistance of the polycarbonate composition. In various embodiments, a method for increasing the water resistance of a polycarbonate composition may involve adding a bishaloformate to the polycarbonate composition, wherein the polycarbonate composition immersed in deionized water for two weeks at 40° C. yields an average unbound bisphenol compound level in water of less than 20 ppb. In various embodiments, a method for increasing the water resistance of a polycarbonate composition including BPA, such as a BPA residue unite, may generally involve adding BPA-BCF to the polycarbonate composition, wherein the polycarbonate composition yields has an average unbound bisphenol A level of less than 20 ppb in water after being immersed in deionized water for two weeks at 40° C.

In various embodiments, the addition of the haloformate to a polycarbonate resin may involve solution blending, bulk blending, melt compounding, and/or melt extruding. For example, suspensions and/or solutions of the haloformate may be mixed with a polycarbonate resin solution. The solvents of the mixed solution/suspension may be evaporated to produce a solid mixture of the polycarbonate resin and the haloformate.

In various embodiments, the polycarbonate resin may be mixed with the bishaloformate, either in bulk or in solution, and then the mixture is melt compounded and/or melt extruded. For example, a solid mixture of the polycarbonate resin and the bishaloformate may be melt compounded and/or melt extruded at a temperature in the range of 250° C. to 360° C., or any sub-range subsumed therein, such as, for example, 250° C. to 350° C., 260° C. to 360° C., and 275° C. to 325° C. In certain embodiments, the method may involve mixing the bishaloformate and the polycarbonate composition, and the mixture may be melt compounded. In certain embodiments, the method may involve mixing the bishaloformate and the polycarbonate composition, and the mixture may be melt extruded.

In various embodiments, a solid mixture of polycarbonate resin and the bishaloformate may be granulated to form pellets and/or powder. In certain embodiments, the method may involve mixing the bishaloformate and the polycarbonate composition, and the mixture may be granulated. The solid mixture of polycarbonate resin and the bishaloformate may be granulated after evaporation of any solvents and/or after melt compounding and/or melt extruding the mixture. The resulting thermoplastic polycarbonate resin compositions may be formed into various articles by a variety of techniques including, for example, injection molding, extrusion, rotation molding, blow molding, thermoforming, and the like.

Polycarbonate compositions in accordance with the various embodiments described herein may include various additives, such as, for example, antioxidants, UV absorbers, light absorbers, peroxide scavengers, metal deactivators, fillers and reinforcing agents, lubricants, plasticizers, optical brighteners, pigments, dyes, colorants, flame-retarding agents, anti-static agents, mold-release agents, and blowing agents.

Examples of suitable antioxidants include, but are not limited to, organophosphites (e.g., tris(nonylphenyl)phosphate; (2,4,6-tri-tert-butylphenyl)(2-butyl-2-ethyl-1,3-propanediol)phosphate; bis(2,4-di-t-butylphenyl)pentaerythritol diphosphite; and distearyl pentaerythritol diphosphite); triphenyl phosphine; alkylated monophenols; polyphenols; alkylated reaction products of polyphenols with dienes (e.g., butylated reaction products of para-cresol and dicyclopentadiene); alkylated hydroquinones; hydroxylated thiodiphenyl ethers; alkylidene-bisphenols; benzyl compounds; acylaminophenols; esters of β-(3,5-di-tert-butyl-4-hydroxyphenol)-propionic acid with monohydric or polyhydric alcohols; esters of β-(5-tert-butyl-4-hydroxy-3-methylphenyl)-propionic acid with monohydric or polyhydric alcohols; esters of β-(5-tert-butyl-4-hydroxy-3-methylphenyl)propionic acid with monohydric or polyhydric alcohols; esters of thioalkyl or thioaryl compounds (e.g., distearylthiopropionate, dilaurylthiopropionate, ditridecylthiodipropionate); and amides of β-(3,5-di-tert-butyl-4-hydroxyphenol)-propionic acid.

Examples of suitable UV absorbers and light absorbers include, but are not limited to, 2-(2′-hydroxyphenyl)-benzotriazoles; 2-hydroxy-benzophenones; esters of substituted and unsubstituted benzoic acids; acrylates; and nickel compounds.

Examples of suitable peroxide scavengers include, but are not limited to, (C₁₀-C₂₀) alkyl esters of betathiodipropionic acid, and mercapto benzimidazole.

Examples of suitable fillers and reinforcing agents include, but are not limited to, silicates, TiO₂, glass fibers, carbon black, graphite, calcium carbonate, talc, and mica.

### EXAMPLES

The non-limiting examples that follow are intended to further describe various embodiments without restricting the scope of the embodiments described in this specification.

The synthesis of the polycarbonate compositions may be carried out using commercially available starting materials. Polycarbonate compositions were prepared using POLYCARBONATE A (MAKROLON 2408, a homopolymer made from bisphenol-A, available from Bayer MaterialScience), and bisphenol-A bischloroformate (BPA-BCF), available from Sigma-Aldrich Corp., St. Louis, Mo., USA.

The polycarbonate compositions were prepared by melting the POLYCARBONATE A in a twin-screw extruder, adding the BPA-BCF directly to the polycarbonate melt, melt blending the components in the extruder, drying the blended extrudate, and dicing the dried extrudate to form pellets using conventional procedures to form pellets. The polycarbonate test specimens were evaluated for water-resistance by immersing 162 g of the pellets in 800 mL of deionized water for two (2) weeks at 40° C. A 700 mL water extract was obtained according to United States Environmental Protection Agency (USEPA) Method 3510C, Revision 3, December 1996, which is incorporated by reference herein. The average concentration of unbound BPA in the water extract was measured by gas chromatography/mass spectrometry (GC/MS) according to USEPA Method 8270C, Revision 3, December 1996, which is incorporated by reference herein. The results are presented in Table 1.

TABLE 1

| | | Average |
|---|---|---|
| | | unbound BPA |
| Example | Compound | level (ppb) |
| C1 | POLYCARBONATE A | 13 |
| C2 | Re-extruded POLYCARBONATE A | 20 |
| C3 | POLYCARBONATE A + 0.1% | 25 |
| | trimethylbenzoate | |
| 4 | POLYCARBONATE A + 0.05% BPA-BCF | 15 |
| 5 | POLYCARBONATE A + 0.1% BPA-BCF | 13 |
| 6 | POLYCARBONATE A + 0.25% BPA-BCF | 11 |

Comparative Examples 1 and 2 show that the average concentration of unbound BPA in the water extract for POLYCARBONATE A, was 13 ppb and re-extruded POLYCARBONATE A was 20 ppb, respectively. Comparative Example 3 shows that the average concentration of unbound BPA in the water extract for POLYCARBONATE A and trimethylbenzoate was 25 ppb. Thus, the conventional BPA scavenger failed to reduce unbound BPA levels relative to POLYCARBONATE A. Moreover, re-extruded POLYCARBONATE A (Comparative Example 2) shows that the melt blending process itself is detrimental to polycarbonate water resistance. On the other hand, the average concentration of unbound BPA in the water extract for POLYCARBONATE A including 0.05%, 0.1%, and 0.25% BPA-BCF, by weight of the composition, was 15 ppb, 13 ppb, and 11 ppb, respectively. Examples 4-6 show that the compositions of the present invention that include POLYCARBONATE A and BPA-BCF reduced unbound BPA levels relative to POLYCARBONATE A and re-extruded POLYCARBONATE A (Comparative Examples 1 and 2, respectively). Thus, melt compounding POLYCARBONATE A and BPA-BCF decreases the propensity of polycarbonate to be hydrolyzed by water. Without wishing to be bound to any particular theory, that the present inventors believe the BPA-BCF generates acid in the composition that stabilizes the polycarbonate.

This specification has been written with reference to various non-limiting and non-exhaustive embodiments. However, it will be recognized by persons having ordinary skill in the art that various substitutions, modifications, or combinations of any of the disclosed embodiments or portions thereof may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicants reserve the right to amend the claims during prosecution to add features as variously described in this specification, and such amendments comply with the requirements of 35 U.S.C. §112, first paragraph, and 35 U.S.C. §132(a).

What is claimed is:

1. A composition, comprising:
a polycarbonate comprising a bisphenol compound; and
an effective amount of an added bishaloformate component present in an amount sufficient to reduce the average unbound bisphenol compound level found in water after immersion in deionized water for two weeks at 40° C. to less than about 20 ppb.

2. The composition according to claim 1, wherein the bishaloformate component is present in an amount of about 0.05% to about 1% by weight of the composition.

3. The composition according to claim 1, wherein the bishaloformate is present in an amount of about 0.05% to about 0.75%.

4. The composition according to claim 1, wherein the bishaloformate is present in an amount of about 0.05% to about 0.5%.

5. The composition according to claim 1, wherein the bishaloformate is present in an amount of about 0.05% to about 0.25%.

6. The composition according to claim 1, wherein the bishaloformate is present in an amount of about 0.1% to about 0.3%.

7. The composition according to claim 1, wherein the bisphenol compound comprises bisphenol A, and the composition yields an average unbound bisphenol A level found in water after immersion in deionized water for two weeks at 40° C. of greater than 0 to about 15 ppb.

8. The composition according to claim 7, wherein the composition has an average unbound bisphenol A level found in water after immersion in deionized water for two weeks at 40° C. of about 1 ppb to about 10 ppb.

9. The composition according to claim 7, wherein the bishaloformate compound is an aromatic bishaloformate.

10. The composition according to claim 7, wherein the bishaloformate compound is bisphenol-A-bischloroformate.

11. The composition according to claim 1, wherein the composition is free of bisphenol A scavengers.

12. A method for increasing the water resistance of a polycarbonate composition, the method comprising:
adding an effective amount of a bishaloformate component to the polycarbonate composition such that the polycarbonate composition yields an average unbound bisphenol compound level found in water after immersion in deionized water for two weeks at 40° C. of less than about 20 ppb.

13. The method according to claim 12, wherein the adding comprises adding about 0.05% to about 1%, by weight of the bishaloformate component to the polycarbonate composition.

14. The method according to claim 12, wherein the bishaloformate is bisphenol-A-bischloroformate.

15. The method according to claim 12, wherein the bishaloformate is added in an amount of about 0.05% to about 0.75%.

16. The method according to claim 12, wherein the bishaloformate is added in an amount of about 0.05% to about 0.5%.

17. The method according to claim 12, wherein the bishaloformate is added in an amount of about 0.05% to about 0.25%.

18. The method according to claim 12, wherein the bishaloformate is added in an amount of about 0.1% to about 0.3%.

19. The method according to claim 12 further comprising mixing the bishaloformate and the polycarbonate composition, and the melt compounding the mixture.

20. The method according to claim 12, further comprising mixing the bishaloformate and the polycarbonate composition, and melt extruding the mixture.

21. The method according to claim 12, further comprising mixing the bishaloformate and the polycarbonate composition, and granulating the mixture.

22. A composition, comprising:
a polycarbonate comprising bisphenol A residues; and
an effective amount of a bisphenol-A-bischloroformate, wherein the composition yields an average unbound bisphenol A level found in water after immersion in deionized water for two weeks at 40° C. of less than about 20 ppb.

23. The composition according to claim 22, wherein the bisphenol-A-bischloroformate is present in an amount of about 0.05% to about 1% by weight of the composition.
